(19) United States
(12) Patent Application Publication
(10) Pub. No.: US 2026/0187131 A1
(43) Pub. Date: Jul. 2, 2026

(54) SYSTEMS AND METHODS FOR TICKET FIELDS PREDICTION FROM HISTORICAL SERVICE TICKETS

(71) Applicant: Automation Anywhere, Inc., San Jose, CA (US)

(72) Inventors: Antonio NUCCI, San Jose, CA (US); Muddu SUDHAKAR, Saratoga, CA (US); Christos TRYFONAS, Foster City, CA (US); Purushottam AMRADKAR, Sammamish, WA (US)

(21) Appl. No.: 19/036,847

(22) Filed: Jan. 24, 2025

Related U.S. Application Data
(60) Provisional application No. 63/626,755, filed on Jan. 30, 2024.

(51) Int. Cl. G06F 16/34; G06F 16/353

(52) U.S. Cl. CPC G06F 16/345; G06F 16/353

(57) ABSTRACT

Described herein are methods, systems, and media for ticket field values prediction from historical or open service tickets comprising service ticket summarization and intent extraction and ticket field values prediction in off-line training or real-time prediction pipelines.

### CROSS-REFERENCE

This application claims the benefit of U.S. Provisional Application No. 63/626,755, filed Jan. 30, 2024, which is hereby incorporated by reference in its entirety herein for all purposes.

### BACKGROUND

Generative artificial intelligence (AI) is artificial intelligence capable of generating text, images, or other media, using generative models. Advances in transformer-based deep neural networks have enabled a number of generative AI systems notable for accepting natural language prompts as input. One such type of model, a large language model (LLM), is a deep learning algorithm that can recognize, summarize, translate, predict and generate text and other forms of content based on knowledge gained from massive datasets. LLMs cans improve enterprise operations, making them more efficient, accurate, and personalized.

### SUMMARY

In one aspect disclosed herein is a computer-implemented method of ticket field value prediction from historical service tickets comprising: providing an off-line training pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, training a ticket intent to ticket field values model using the one or more historical service ticket intents and the one or more historical service ticket field values to predict the historical service ticket field values from the historical service ticket intents; and providing a real-time prediction pipeline configured to perform real-time operations including: receiving an open service ticket, applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, applying the ticket intent to ticket field values model to predict one or more open service ticket field values from the one or more open service ticket intents, and providing the one or more open service ticket field values. In some embodiments, the ticket summarization and intent extraction model comprises an LLM. In some embodiments, the erroneous details comprise one or more of a salutation, an external link, a proposed solution, contact information, a personal identifier, or narrative details. In some embodiments, the summarizing operation of the off-line operations or the real-time operations generates a summary, wherein the summary comprises one or more of an error message, a status code, a warning message, a system warning, a reference to a product, or an intent. In some embodiments, the one or more historical service ticket intents or the one or more open service ticket intents indicate an information request, an issue, or a question. In some embodiments, the one or more open service ticket field values are used to route the open service ticket to one or more of a service agent, a department, a domain expert, or a customer relationship management (CRM) software. In some embodiments, the historical service ticket field values or the open service ticket field values comprise at least one category, wherein a second or later category further defines the at least one category. In some embodiments, the off-line operations further include flattening the one or more historical service ticket field values to comprise a sequence of dependent field values. In further embodiments, the flattening operation is used to generate a label for training the ticket intent to ticket field values model. In some embodiments, the ticket intent to ticket field values model comprises an LLM. In some embodiments, the ticket intent to ticket field values model is trained on a library of historical service tickets, wherein the library comprises at least 100, 200, 300, 400, 500, 600, 700, 800, 900, 1000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more historical service tickets, including increments therein.

In another aspect disclosed herein is a computer-implemented method for ticket field values predictions from historical service tickets comprising: providing an off-line prediction pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, generating a ticket fields definition file comprising each of the historical service ticket field values, wherein each of the plurality of historical service ticket intents is mapped to one of the one or more historical service ticket field values; and providing a real-time prediction pipeline configured to perform real-time operations including: receiving an open service ticket, applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, providing a prompt comprising the ticket fields definition file or the one or more open service ticket intents to a ticket field prediction model to predict one or more open service ticket field values, and providing the one or more open service ticket field values. In some embodiments, the generating the ticket fields definition file comprises operations including: clustering the historical service tickets by the one or more historical service ticket field values to form one or more groups, clustering the one or more groups by the one or more historical service ticket intents to form one or more sub-groups, removing a weakly represented portion of the one or more historical service ticket intents from each of the one or more sub-groups based on a cutoff threshold of proportional representation, removing a colliding historical service ticket intent from all except one of the one or more sub-groups, wherein the colliding historical service ticket intent comprises a historical service ticket intent associated with at least two of the one or more sub-groups, and generating the ticket fields definition file comprising the one or more sub-groups, wherein the one or more sub-groups of the ticket fields definition file comprise unique associations between the one or more historical service ticket intents and the one or more historical service ticket field values. In further embodiments, the colliding event is removed based on one or more metrics comprising a recency of association of the historical service ticket intent with the one or more sub-groups or a popularity of association of the historical service ticket intent with the one or more sub-groups. In further embodiments, the cutoff threshold is set to retain at least 1%, 5%, 10%, 15%, 20%, 25%, 30%, 35%, 40%, 45%, 50%, 55%, 60%, 65%, 70%, 75%, 80%, 85%, 90%, 95%, or 100% historical service ticket intents, including increments therein. In further embodiments, the generating the ticket fields definition file operations further include forming a sub-group using the portion of weakly represented historical service ticket intents. In further embodiments, the generating the ticket fields definition file operations further include summarizing each sub-group. In yet further embodiments, the generating the ticket fields definition file is performed by an LLM. In some embodiments, the providing the prompt operation of the real-time operations comprises operations including: prompt engineering the ticket field prediction model with at least the ticket fields definition file, and predicting the one or more open service ticket field values using the prompt engineered ticket field prediction model. In yet further embodiments, the ticket field prediction model is an LLM. In some embodiments, the prompt further comprises instructions to complete a form, wherein the form comprises one or more key-value pairs, wherein the keys of the one or more key-value pairs comprise a category, a category confidence, one or more sub-categories, one or more sub-category confidences, an issue type, an issue type confidence, a payroll impact, a payroll impact confidence, a system, or a system confidence. In some embodiments, the ticket summarization and intent extraction model comprises an LLM. In some embodiments, the erroneous details comprise one or more of a salutation, an external link, a proposed solution, contact information, a personal identifier, or narrative details. In some embodiments, the summarizing operation of the off-line operations or the real-time operations generates a summary, wherein the summary comprises one or more of an error message, a status code, a warning message, a system warning, a reference to a product, or an intent. In some embodiments, the one or more historical service ticket intents or the one or more open service ticket intents indicates an information request, an issue, or a question. In some embodiments, the one or more open service ticket field values are used to route the open service ticket to one or more of a service agent, a department, a domain expert, or a customer relationship management (CRM) software. In some embodiments, the historical service ticket field values or the open service ticket field values comprise at least one category, wherein a second or later category further defines the at least one category. In some embodiments, the off-line operations further include flattening the one or more historical service ticket field values to comprise a sequence of dependent field values. In some embodiments, the ticket fields definition file is generated by a person.

In yet another aspect disclosed herein is a computer-implemented system comprising at least one processor and instructions causing the at least one processor to perform operations comprising: providing an off-line training pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, training a ticket intent to ticket field values model using the one or more historical service ticket intents and the one or more historical service ticket field values to predict the historical service ticket field values from the historical service ticket intents; and providing a real-time prediction pipeline configured to perform real-time operations including: receiving an open service ticket, applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, applying the ticket intent to ticket field values model to predict one or more open service ticket field values from the one or more open service ticket intents, and providing the one or more open service ticket field values. In some embodiments, the ticket summarization and intent extraction model comprises an LLM. In some embodiments, the erroneous details comprise one or more of a salutation, an external link, a proposed solution, contact information, a personal identifier, or narrative details. In some embodiments, the summarizing operation of the off-line operations or the real-time operations generates a summary, wherein the summary comprises one or more of an error message, a status code, a warning message, a system warning, a reference to a product, or an intent. In some embodiments, the one or more historical service ticket intents or the one or more open service ticket intents indicates an information request, an issue, or a question. In some embodiments, the one or more open service ticket field values are used to route the open service ticket to one or more of a service agent, a department, a domain expert, or a customer relationship management (CRM) software. In some embodiments, the historical service ticket field values or the open service ticket field values comprise at least one category, wherein a second or later category further defines the at least one category. In some embodiments, the off-line operations further include flattening the one or more historical service ticket field values to comprise a sequence of dependent field values. In further embodiments, the flattening operation is used to generate labels for training the ticket intent to ticket field values model. In some embodiments, the ticket intent to ticket field values model comprises an LLM. In some embodiments, the ticket intent to ticket field values model is trained on a library of historical service tickets, wherein the library comprises at least 100, 200, 300, 400, 500, 600, 700, 800, 900, 1000, 2,000, 3,000, 4,000, 5,000, 6,000, 7,000, 8,000, 9,000, 10,000, 20,000, 30,000, 40,000, 50,000, 60,000, 70,000, 80,000, 90,000, 100,000, 200,000, 300,000, 400,000, 500,000, 600,000, 700,000, 800,000, 900,000, 1,000,000, or more historical service tickets, including increments therein. In some embodiments, the system is disposed between a user computing device and a third-party platform. In further embodiments, the third-party platform comprises one or more of an LLM, a CRM software, or a service agent. In some embodiments, the open service ticket is received from a user device or a database. In some embodiments, the historical service tickets are received from a database. In further embodiments, the database comprises one or both of a plurality of physical or a plurality of virtual historical service tickets.

In still another aspect disclosed herein is a computer-implemented system comprising at least one processor and instructions causing the at least one processor to perform operations comprising: providing an off-line prediction pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, generating a ticket fields definition file comprising each of the historical service ticket field values, wherein each of the plurality of historical service ticket intents is mapped to one of the one or more historical service ticket field values; and providing a real-time prediction pipeline configured to perform real-time operations including: receiving an open service ticket, applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, providing a prompt comprising the ticket fields definition file or the one or more open service ticket intents to a ticket field prediction model to predict one or more open service ticket field values, and providing the one or more open service ticket field values. In some embodiments, the generating the ticket fields definition file comprises operations including: clustering the historical service tickets by the one or more historical service ticket field values to form one or more groups, clustering the one or more groups by the one or more historical service ticket intents to form one or more sub-groups, removing a weakly represented portion of the one or more historical service ticket intents from each of the one or more sub-groups based on a cutoff threshold of proportional representation, removing a colliding historical service ticket intent from all except one of the one or more sub-groups, wherein the colliding historical service ticket intent comprises a historical service ticket intent associated with at least two of the one or more sub-groups, and generating the ticket fields definition file comprising the one or more sub-groups, wherein the one or more sub-groups of the ticket fields definition file comprise unique associations between the one or more historical service ticket intents and the one or more historical service ticket field values. In further embodiments, the colliding event is removed based on one or more metrics comprising a recency of association of the historical service ticket intent with the one or more sub-groups or a popularity of association of the historical service ticket intent with the one or more sub-groups. In further embodiments, the cutoff threshold is set to retain at least 1%, 5%, 10%, 15%, 20%, 25%, 30%, 35%, 40%, 45%, 50%, 55%, 60%, 65%, 70%, 75%, 80%, 85%, 90%, 95%, or 100% historical service ticket intents, including increments therein. In further embodiments, the generating the ticket fields definition file operations further include forming a sub-group using the portion of weakly represented historical service ticket intents. In further embodiments, the generating the ticket fields definition file operations further include summarizing each sub-group. In yet further embodiments, the generating the ticket fields definition file is performed by an LLM. In some embodiments, the providing the prompt operation of the real-time operations comprises operations including: prompt engineering the ticket field prediction model with at least the ticket fields definition file, and predicting the one or more open service ticket field values using the prompt engineered ticket field prediction model. In further embodiments, the ticket field prediction model is an LLM. In some embodiments, the prompt further comprises instructions to complete a form, wherein the form comprises one or more key-value pairs, wherein the keys of the one or more key-value pairs comprise a category, a category confidence, one or more sub-categories, one or more sub-category confidences, an issue type, an issue type confidence, a payroll impact, a payroll impact confidence, a system, or a system confidence. In some embodiments, the ticket summarization and intent extraction model comprises an LLM. In some embodiments, the erroneous details comprise one or more of a salutation, an external link, a proposed solution, contact information, a personal identifier, or narrative details. In some embodiments, the summarizing operation of the off-line operations or the real-time operations generates a summary, wherein the summary comprises one or more of an error message, a status code, a warning message, a system warning, a reference to a product, or an intent. In some embodiments, the one or more historical service ticket intents or the one or more open service ticket intents indicates an information request, an issue, or a question. In some embodiments, the one or more open service ticket field values are used to route the open service ticket to one or more of a service agent, a department, a domain expert, or a customer relationship management (CRM) software. In some embodiments, the historical service ticket field values or the open service ticket field values comprise at least one category, wherein a second or later category further defines the at least one category. In some embodiments, the off-line operations further include flattening the one or more historical service ticket field values to comprise a sequence of dependent field values. In some embodiments, the third-party platform comprises one or more of an LLM, a CRM software, or a service agent. In some embodiments, the open service ticket is received from a user device or a database. In some embodiments, the historical service tickets are received from a database. In further embodiments, the database comprises one or both of a plurality of physical or a plurality of virtual historical service tickets.

A yet further aspect disclosed herein is one or more non-transitory computer-readable storage media encoded with instructions executable by one or more processors to provide an application comprising: a software module providing an off-line training pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, training a ticket intent to ticket field values model using the one or more historical service ticket intents and the one or more historical service ticket field values to predict the historical service ticket field values from the historical service ticket intents; and a software module providing a real-time prediction pipeline configured to perform real-time operations including: receiving an open service ticket, applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, applying the ticket intent to ticket field values model to predict one or more open service ticket field values from the one or more open service ticket intents, and providing the one or more open service ticket field values.

A still further aspect disclosed herein is more non-transitory computer-readable storage media encoded with instructions executable by one or more processors to provide an application comprising: a software module providing an off-line prediction pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, generating a ticket fields definition file comprising each of the historical service ticket field values, wherein each of the plurality of historical service ticket intents is mapped to one of the one or more historical service ticket field values; and a software module providing a real-time prediction pipeline configured to perform real-time operations including: receiving an open service ticket, applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, providing a prompt comprising the ticket fields definition file or the one or more open service ticket intents to a ticket field prediction model to predict one or more open service ticket field values, and providing the one or more open service ticket field values.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a non-limiting example of a computing device; in this case, a device with one or more processors, memory, storage, and a network interface, per one or more embodiments herein;

FIG. 2 shows a first diagram of an exemplary technology stack, per one or more embodiments herein;

FIG. 3 shows a second diagram of an exemplary technology stack; in this case, a technology stack with large language model (LLM) emphasis;

FIG. 4 shows a diagram of an exemplary method of prompt registration configured at an admin console through an LLM gateway, per one or more embodiments herein;

FIG. 5 shows a non-limiting example of a graphic user interface (GUI); in this case, a GUI for an admin console showing artificial intelligence (AI) service desk features;

FIG. 6 shows a non-limiting example of a GUI; in this case, a GUI for an admin console showing AI ops desk features;

FIG. 7 shows a non-limiting example of a GUI; in this case, a GUI for an admin console showing AI support intelligence features;

FIG. 8 shows a non-limiting example of a logical architecture of a ticket field values prediction system using a ticket field values prediction model, with both an off-line pipeline and a real-time pipeline for a prediction of ticket field values for service tickets;

FIG. 9 shows a non-limiting example of a logical architecture of a ticket field values prediction system using a ticket fields definition file, with both an off-line pipeline and a real-time pipeline for a prediction of ticket field values for service tickets; and

FIG. 10 shows a non-limiting example of a logical architecture of a pipeline to generate a ticket fields definition file using ticket intents and field values.

### DETAILED DESCRIPTION

Described herein, in certain embodiments, are computer-implemented methods of ticket field value prediction from historical service tickets comprising: providing an off-line training pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, training a ticket intent to ticket field values model using the one or more historical service ticket intents and the one or more historical service ticket field values to predict the historical service ticket field values from the historical service ticket intents; and providing a real-time prediction pipeline configured to perform real-time operations including: receiving an open service ticket, applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, applying the ticket intent to ticket field values model to predict one or more open service ticket field values from the one or more open service ticket intents, and providing the one or more open service ticket field values.

Also described herein, in certain embodiments, are computer-implemented methods for ticket field values predictions from historical service tickets comprising: providing an off-line prediction pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, generating a ticket fields definition file comprising each of the historical service ticket field values, wherein each of the plurality of historical service ticket intents is mapped to one of the one or more historical service ticket field values; and providing a real-time prediction pipeline configured to perform real-time operations including: receiving an open service ticket, applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, providing a prompt comprising the ticket fields definition file or the one or more open service ticket intents to a ticket field prediction model to predict one or more open service ticket field values, and providing the one or more open service ticket field values.

Also described herein, in certain embodiments, are computer-implemented systems comprising at least one processor and instructions causing the at least one processor to perform operations comprising: providing an off-line training pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, training a ticket intent to ticket field values model using the one or more historical service ticket intents and the one or more historical service ticket field values to predict the historical service ticket field values from the historical service ticket intents; and providing a real-time prediction pipeline configured to perform real-time operations including: receiving an open service ticket, applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, applying the ticket intent to ticket field values model to predict one or more open service ticket field values from the one or more open service ticket intents, and providing the one or more open service ticket field values.

Also described herein, in certain embodiments, are computer-implemented systems comprising at least one processor and instructions causing the at least one processor to perform operations comprising: providing an off-line prediction pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, generating a ticket fields definition file comprising each of the historical service ticket field values, wherein each of the plurality of historical service ticket intents is mapped to one of the one or more historical service ticket field values; and providing a real-time prediction pipeline configured to perform real-time operations including: receiving an open service ticket, applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, providing a prompt comprising the ticket fields definition file or the one or more open service ticket intents to a ticket field prediction model to predict one or more open service ticket field values, and providing the one or more open service ticket field values.

Also described herein, in certain embodiments, are one or more non-transitory computer-readable storage media encoded with instructions executable by one or more processors to provide an application comprising: a software module providing an off-line training pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, training a ticket intent to ticket field values model using the one or more historical service ticket intents and the one or more historical service ticket field values to predict the historical service ticket field values from the historical service ticket intents; and a software module providing a real-time prediction pipeline configured to perform real-time operations including: receiving an open service ticket, applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, applying the ticket intent to ticket field values model to predict one or more open service ticket field values from the one or more open service ticket intents, and providing the one or more open service ticket field values.

Also described herein, in certain embodiments, are one or more non-transitory computer-readable storage media encoded with instructions executable by one or more processors to provide an application comprising: a software module providing an off-line prediction pipeline configured to perform off-line operations including: receiving a plurality of historical service tickets each comprising one or more historical service ticket field values, applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries, generating a ticket fields definition file comprising each of the historical service ticket field values, wherein each of the plurality of historical service ticket intents is mapped to one of the one or more historical service ticket field values; and a software module providing a real-time prediction pipeline configured to perform real-time operations including: receiving an open service ticket, applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary, providing a prompt comprising the ticket fields definition file or the one or more open service ticket intents to a ticket field prediction model to predict one or more open service ticket field values, and providing the one or more open service ticket field values.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “of” herein is intended to encompass “and/of” unless otherwise stated.

As used herein, the term “about” in some cases refers to an amount that is approximately the stated amount, in some cases near the stated amount by 10%, 5%, or 1%, including increments therein, and in some cases, in reference to a percentage, refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C”, “one or more of A, B, or C” and “A, B, and/or C” means A alone, B alone, C alone, A and B together, A and C together, B and C together, or A, B and C together.

Service Ticket: As used herein, “service ticket” in some cases refers to a communication from a user describing one or more technical issues or questions experienced by the user with the purpose of obtaining a resolution to the one or more technical issues or questions.

Ticket Field Value: As used herein, “ticket field value,” “ticket field,” or any plural form of either “ticket field value,” or “ticket field” in some cases refers to a label assigned to a service ticket for use in service ticket routing.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing Systems

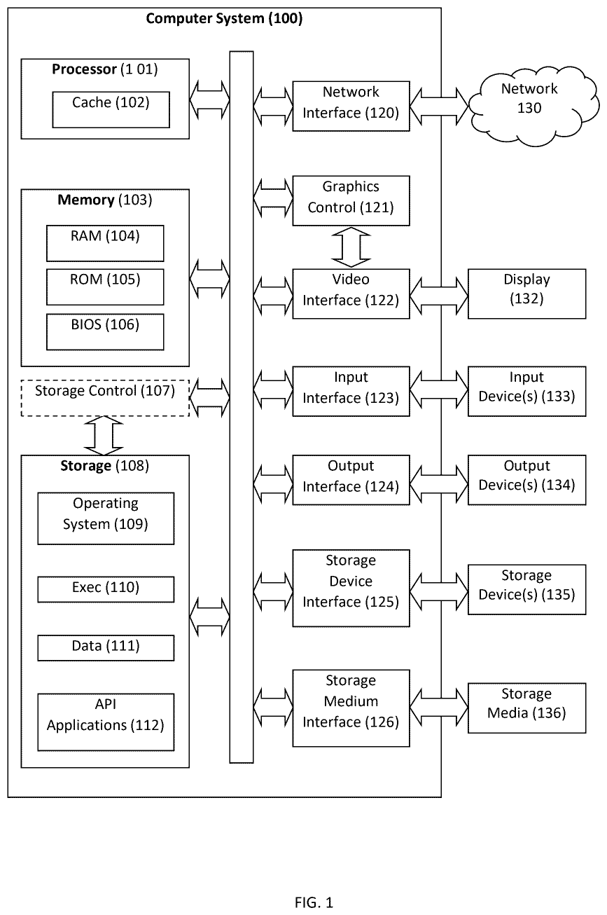

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs) or general purpose graphics processing units (GPGPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, and netpad computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of historical service tickets or open service tickets. In various embodiments, suitable databases include, by way of non-limiting examples, relational databases, non-relational databases, object-oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### LLM Technology Stack

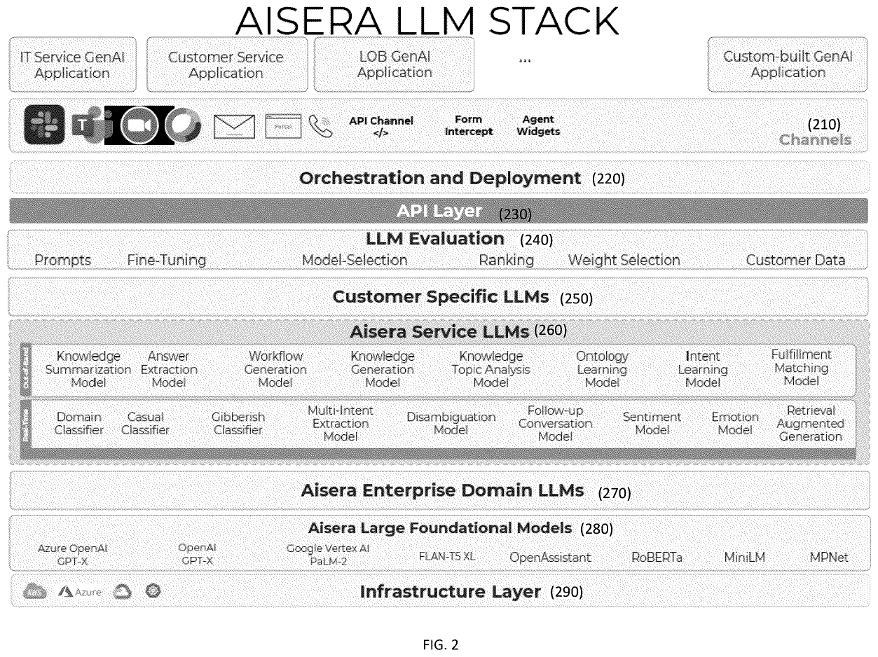

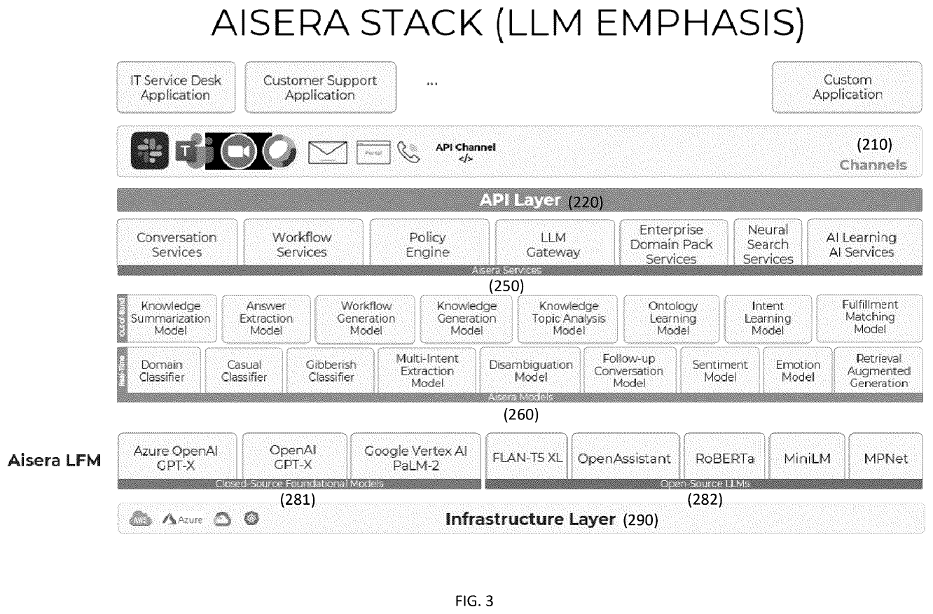

FIGS. 2 and 3 show diagrams of an exemplary Large Language Model (LLM) Technology Stack. In some embodiments, the LLM stack herein can be deployed, scaled and operated both in public clouds (AWS, GCP, Azure, etc.) on an Infrastructure Layer 290 and locally (on-premise) using the Kubernetes container orchestration platform.

In some embodiments, the LLM stack herein embeds a plurality of large foundational models (LFMs) 280, including both closed-source LFMs 281 via an API layer 230 integrated with LFMs, and open-source LFMs 282 via the LFM deployment and execution in secure Kubernetes containers. Non-limiting examples of closed-source LFM providers which are integrated with The LLM stack herein via APIs are Azure OpenAI (complete and chat APIs for GPT-3, GPT-3.5, and GPT-4), OpenAI (complete and chat APIs for GPT-3, GPT-3.5 and GPT-4), Google Vertex AI (PaLM-2). Non-limiting examples of open-source LFM are FLAN-T5, OpenAssistant, RoBERTa, MiniLM, and MPNet.

In some embodiments, the LLM stack herein enables a developer to choose from a pool of supported LFM/LLM models using a catalog, or to integrate a new LFM/LLM model using the LLM Gateway. In some embodiments, the LLM Gateway Toolkit allows the developer to select the LFM provider of choice, either from a catalog or by selecting “New LFM” (in which case he needs to provide the LFM Provider URL and the API Credentials to establish a successful connection), create a new LLM Group, which is a logical folder associated to the developer, and simply upload the new LLM models in the LLM group.

The LLM stack herein provides the developer with the flexibility of choosing both the LFM framework and a customer-specific LLM model 250 for any given task based on the different LLM services needed to operate a conversational AI assistant. As a result, in some embodiments, developers can develop end to end LLM workflows or LLM services 260 which comprise more than one task by choosing a specific LFM/LLM model for each specific task to be executed in the pipeline.

In some embodiments, developers can calibrate each model per their objectives to deliver a high level of precision and accuracy. In some embodiments, LLM stack herein allows the developer to calibrate the mode using the below behaviors:

Zero-shot Learning: The developer can use the pre-trained LLM model as-is. Examples of such tasks are language detection, language translation, sentiment detection, emotion detection, etc.

Few-shots Learning (e.g., prompt engineering or inference-time tuning): In some embodiments, the developer guides the model to the desired output by providing the LLM model with few examples and instructions. In some embodiments, this calibration model does not alter the underlying parameters of the LLM models.

Instruction-based Fine-Tuning: This method may provide a higher level of precision and accuracy than zero-shot or few-shot learnings. In some embodiments, in this method, the developer trains the model using specialized datasets, which are high-quality human-generated prompt/response pairs specifically designed for instruction tuning LLMs. In some embodiments, this method of calibration acts deeper in the LLM model by updating the internal parameters used by the model. The model fine-tuning is the most advanced calibration method and may require both computing resources for training and supervised, high-quality and extensive datasets to generate the prompt/response sentence pairs for training.

In some embodiments, the Large Language Model (LLM) technology stack herein can operate in multiple industry verticals (e.g., logistics, healthcare, wealth management, retailers, banking, airlines, and insurance) and enterprise domains 270 (e.g., IT, HR, legal and compliance, finance, supply chain management, facilities). The Enterprise Domain LLMs are LLM models which have been extensively fine-tuned using prompt/response sentence pairs extracted from Enterprise Domain Packs (EDPs). In some embodiments, each Enterprise Domain Pack comprises a domain-specific ontology, which is an extensive set of entity classes, entity names, entity synonymous like entity expansions, and abbreviations (initialisms, acronymous, shortenings and contractions) and domain-specific taxonomy, which is an extensive set of intents (and intent phrases) associated to each entity of the ontology. Each domain EDP may comprise hundreds of thousands to millions of intent phrases.

In some embodiments, the Large Language Model (LLM) technology stacks herein use pre-packaged and fine-tuned a large pool of domain-specific LLM Services 260 using one or more EDPs. The LLM Services 260 may be available to developers in a Service LLM catalog. In some embodiments, the developer uses the LLM Services 260 via an API, or can select or drag/drop/chain them into a conversational workflow using a studio to build complete experiences around a service.

In some embodiments, the LLM stack herein provides a further level of LLM model customization beyond the calibration offered via the instruction-fine tuning and EDP. The Large Language Model (LLM) technology stack herein offers special learning pipelines, which act on the specific customer datasets (e.g., tickets, knowledge articles, call transcripts, etc.) which may automatically extract entities and intents which are very specific to the customer (e.g., within the domain of operation). In some embodiments, this custom-specific knowledge is then used to generate custom-specific prompt/responses which may then be used to execute a second round of instruction-based fine tuning on a proprietary Enterprise Domain LLMs, which may be fine-tuned using only the domain-specific EDPs. Exemplary proprietary AI Learning pipelines directly linked to instruction-based fine-tuning pf LLM models are listed below:

Tickets Learning Pipeline: Iteratively and continuously processes tickets and automatically extracts the main entities and associated intents. By grouping tickets tagged with the same pair of intents and entities, the pipeline may automatically generate intent phrases capturing the language diversity used by the specific customer to express the same concept.

Conversation Learning Pipeline: Iteratively and continuously processes user requests and calls transcripts, and automatically extracts the main entities and associated intents. By grouping conversations tagged with the same pair of intent and entity, the pipeline may automatically generate intent phrases capturing the language diversity used by the specific customer to express the same concept.

Knowledge Learning Pipeline: Processes ingested customer knowledge articles and may automatically extract the main entities, associated intents and large set of intent phrases from each article.

Ontology Generation: Consumes all the entity-based learning from the different pipelines, may automatically discover expansions, abbreviations, and relationships among the entities, and organizes all the entities into an ontology graph which may be made available as a catalog.

Taxonomy Generation: Consumes all the intent-based learning from the different pipelines and may automatically organize all semantic similar intents into a multi-category multi-level intent taxonomy which is made available as a catalog.

In some embodiments, the LLM stack herein provides an LLM evaluation level 240, which the user with a set of toolkits and APIs that developers can use to evaluate the performance of the LLM models herein. Developers can access toolkits and APIs for development, testing and benchmarking the following: prompt engineering (e.g., few shots learning), fine tuning, Model Selection via LLM catalog and LLM Gateway, model performance ranking which automatically scores the models against the same dataset to automatically stack rank LFM/LLM models based on the accuracy achieved, and manage customer datasets for instruction-fine tuning models.

In some embodiments, the LLM stack herein offers a comprehensive Orchestration and Deployment Layer 220 that is used to allocate and deploy resources (including servers, virtual machines, networking, security and storage), monitor software lifecycle operations, and recover from error conditions. In some embodiments, the LLM stack herein offers a large diversity of channels 210 to interface with users like Slack, Microsoft Teams, Cisco WebEx, Zoom, SMS/MMS, Email and Voice), Administrator Portal, Form Intercept and Agent Widgets.

In some embodiments, prompts can have a separate LLM Provider, internal or external (e.g., OpenAI, Bard, etc.). Input Variables can be passed into prompts (e.g. Chat history). In some embodiments, prompt groups and/or prompt chaining is implemented as well.

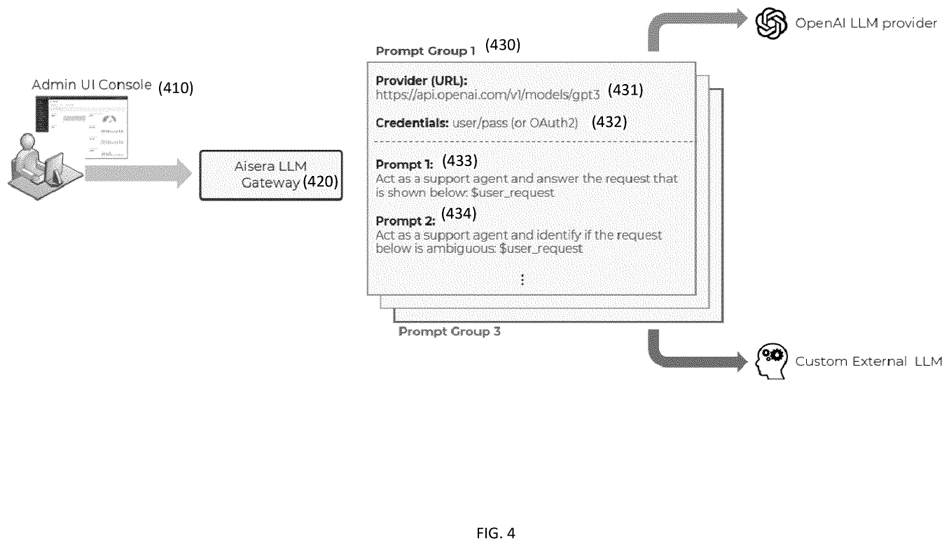

In some embodiments, per FIG. 4, an LLM provider is registered through a LLM Gateway by an Admin UI console 410. In some embodiments, prompts are added that will be used mainly for preconfigured Tasks through the LLM Gateway 420 (e.g., an Admin UI console). In some embodiments, calling the registered prompts can be performed by using a prompt for the main NLU path by inserting them inside the Pre-Handling Flow, or as an auxiliary capacity, by adding prompts inside a flow (e.g., using the new LLM action). In the example shown, a first prompt group 430 comprises a provider URL 431 and the associated credentials 432, a first prompt 433, and a second prompt 434. As shown, the first prompt 433 and the second prompt 434 of the first prompt group 430 are sent to an OpenAI LLM provider 450. Further, a second prompt group 440 is sent based on its provider URL (not shown), to a custom external LLM 460. In some embodiments, the LLM Gateway 420 determines, based on the prompt, the provider URL 431, the associated credentials 432, or any combination thereof whether to send the prompt to the OpenAI LLM provider 450 or to the custom external LLM 460. In some embodiments, the LLM Gateway 420 sends the prompt to the OpenAI LLM provider 450 for general prompts that can be answered by the OpenAI LLM provider 450. In some embodiments, the LLM Gateway 420 sends prompts specific to an organization, an application, or other specialized department to the custom external LLM 460.

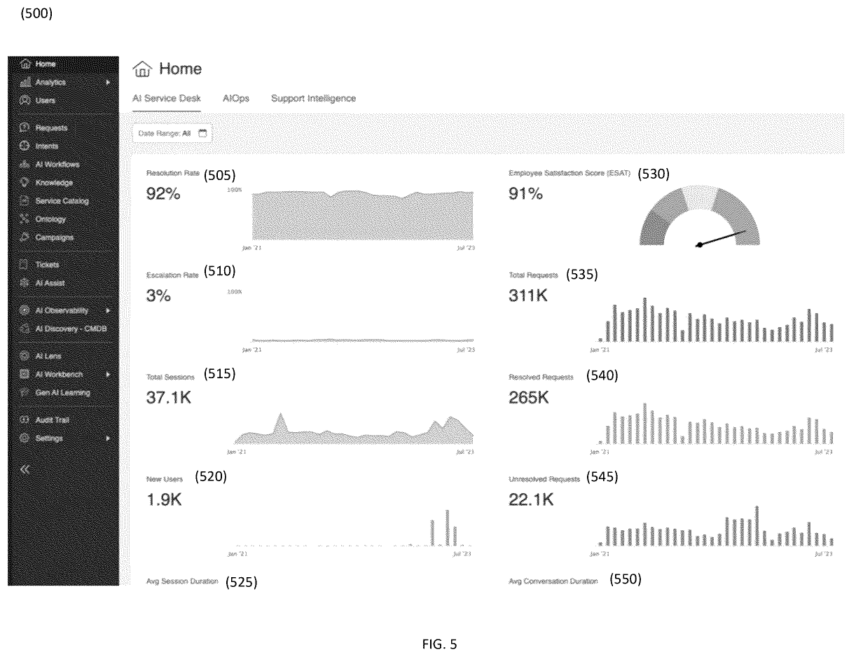

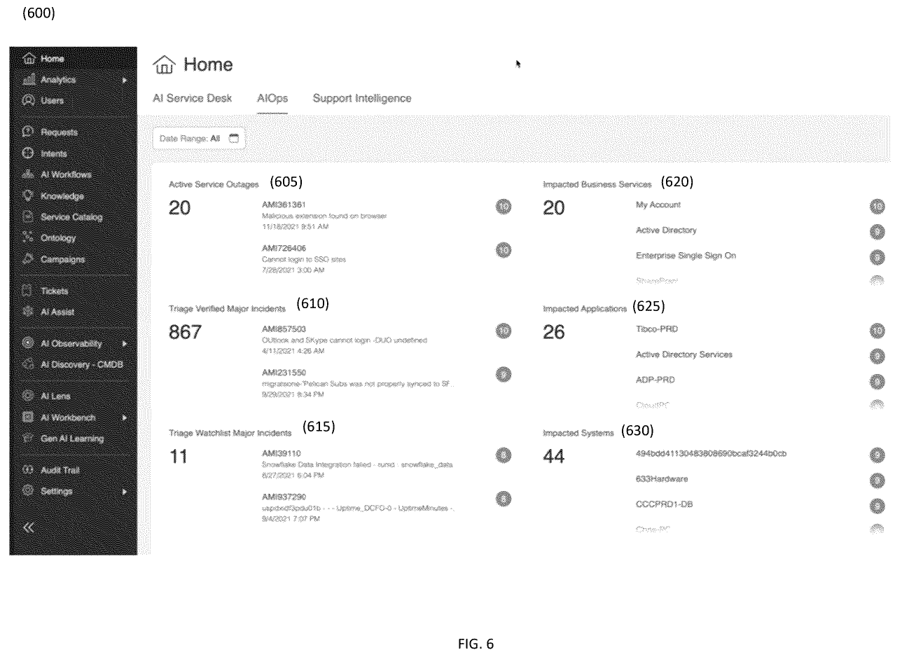

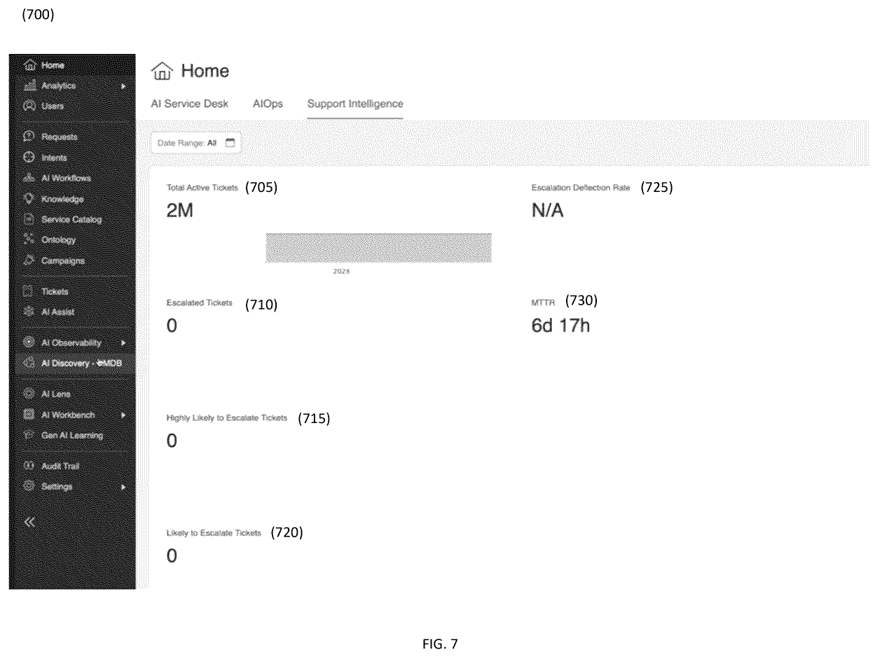

In some embodiments, technology stack described herein includes an administrative (or admin) console. In further embodiments, the admin console includes a front-end interface, such as a GUI. In still further embodiments, the GUI includes features allowing an admin user to review and configure features of the technology described herein. By way of example, in some embodiments, per FIG. 5, a GUI for an admin console 500 includes navigation elements allowing a user to access, by way of examples, analytics, users, requests, intents, AI workflows, knowledge bases, service catalogs, ontologies, campaigns, tickets, AI assist, AI observatory, AI discovery, AI lens, AI workbench, gen AI learning, an audit trail, and settings. Further, in some embodiments, per FIG. 5, a GUI for an admin console 500 includes an AI service deck feature providing access to data pertaining to, for example, resolution rates 505, escalation rates 510, total sessions 515, new users 520, average session duration 525, employee satisfaction score 530, total requests 535, resolved requests 540, unresolved requests 545, and average conversation duration 550. By way of further example, in some embodiments, per FIG. 6, a GUI for an admin console 600 includes an AI ops feature providing access to data pertaining to, for example, active service outages 605, triage verified major incidents 610, triage watchlist major incidents 615, impacted business services 620, impacted applications 625, and impacted systems 630. By way of still further example, in some embodiments, per FIG. 7, a GUI for an admin console 700 includes an support intelligence feature providing access to data pertaining to, for example, total active tickets 705, escalated tickets 710, highly likely to escalate tickets 715, likely to escalate tickets 720, escalation deflection rate 725, and mean time to recovery, repair, respond, or resolve (MTTR) 730.

### Overview

In some embodiments, the platforms, systems, media, and methods disclosed herein include ticket field values prediction from at least one of an off-line pipeline or a real-time pipeline. In some embodiments, the off-line pipeline may be used to train a ticket intent to ticket field values model to predict historical service ticket field values from a plurality of historical service ticket intents. In some embodiments, the real-time pipeline may implement the ticket intent to ticket field values model to predict one or more open service ticket field values from one or more open service ticket intents. In some embodiments, a ticket summarization and intent extraction model may be used to extract the one or more historical service ticket intents from the plurality of historical service tickets or the one or more open service ticket intents from the open service ticket. In some embodiments, a summarization operation of the ticket summarization and intent extraction module may comprise removing erroneous details while retaining a summary. In some embodiments, the erroneous details may comprise one or more of a salutation, an external link, a proposed solution, contact information, a personal identifier, or narrative details. In some embodiments, the summary may comprise one or more intents and one or more of an error message, a status code, a warning message, a system warning, or a reference to a product, wherein the one or more intents may comprise a request, an issue, or a question. In some embodiments, the ticket field values may be flattened, wherein the ticket field values comprise one or more categories ordered sequentially, wherein the order may be dependent on a granularity of detail such that each subsequent category further clarifies a first category. In some embodiments, the off-line pipeline may comprise a generating operation to generate a ticket fields definition file, wherein the ticket fields definition file comprises each of the one or more historical service ticket intents mapped to one of the one or more historical service ticket field values. In some embodiments, the ticket fields definition file may be used as a prompt for input into a ticket field prediction model to predict the one or more open service ticket field values from the one or more open service ticket intents. In some embodiments, the one or more open service ticket field values may be provided to a service agent, a department, a domain expert, or a customer relationship management software.

In some embodiments, the platforms, systems, media, and methods disclosed herein may address issues of computational or business efficiency. In some embodiments, the platforms, systems, media, and methods disclosed herein may be integrated into a CRM system or a ticketing system to provide artificial intelligence-based recommendations for ticket field values based on learned associations between service ticket intents and service ticket field values. In some embodiments, the learned associations may enable accurate and precise allocation of service tickets to a department, CRM software, one or more service agents, one or more domain experts, or one or more other service ticket resolution resources. The various embodiments disclosed herein provide at least improved, particular platforms, systems, media, and methods for the efficient routing or allocation of service tickets, for example for an internal or external source of user issues, questions, or information requests (e.g., employee issues or customer issues). In some embodiments, the efficient routing of service tickets is enabled by the accurate and precise prediction of ticket field values, where ticket field values represent, for example, a category or labelling technique (e.g., literal labels or learned associations between tickets and departments or other resolution means) used to route service tickets to resolution resources. In some embodiments, the accurate and precise routing of service tickets addresses long-standing issues in trustworthiness in systems with poor routing (e.g., customer cannot find answers to issues due to incorrect service ticket allocation) and wasted computational and business resources due to incorrectly routed tickets.

It will be understood in the following functional components that reference to service tickets is not limiting to either open or historical service tickets. Functional component modules include, by way of non-limiting examples:

Ticket Summarization and Intent Extraction Model. A service ticket is ingested by an LLM model to extract a summary and ultimately an intent (or intents) from the service ticket. The ticket summarization and intent extraction model may comprise a series of modules in cascade to perform the summarization and extraction processes. Ticket summarization may include the removal of erroneous detail to generate a summary of the service ticket such that the user intent (e.g., the issue or question to be resolved) and pertinent details (e.g., error codes) may be extracted from the summary. The extraction process may comprise predicting from the summary one or more actionable requests (e.g., a question, statement of issue, knowledge inquiry) in the form of an intent. The extracted intent can then serve as input into a model trained to predict one or more ticket field values, which may more broadly characterize the intent of the service ticket such that the ticket may be accurately routed to a resolution resource.

Ticket Intent to Ticket Field Values Prediction Model. A ticket intent may describe an issue, question, or information request held by a user, but may not be sufficiently abstracted so as to be reliably assigned to a means of resolution (e.g., a service agent or domain expert). A model taking as input ticket intents and outputting field values, trained on a library of historical service tickets passed through a ticket summarization and intent extraction model to obtain ticket intent(s), can provide one means of correlating ticket intent with ticket field values automatically. The ticket intent to ticket field values model can be trained off-line so as to be later used in real-time deployment, simplifying service ticket field values assignment by automating the process and minimizing user ticket field values assignment errors (or assignment by less robust algorithms). The predicted ticket field values may include a flattened representation of categories representing a user issue, such that the ticket field values can retain a degree of granularity via a sequence-based hierarchy of categories linked to comprise the output of the ticket intent to ticket field values model. The ticket intent to ticket field values prediction model may provide a robust means of ticket field values assignment when historical service tickets are numerous (e.g., thousands, hundreds of thousands) and the field values assigned to the historical service tickets are reliable.

Ticket Field Values Definition File Generator. A ticket fields definition file can be generated from service tickets to provide unique associations between ticket intents and ticket field values. A collection of these unique associations can be a component of a prompt for use in prompt engineering of LLMs, where the ticket fields definition file provides a resource from which the prompt engineered LLM can pull to provide ticket field values for service ticket intents in a real-time deployment of a system or method for ticket field values prediction. The ticket field fields definition file generator can be considered as a sequence of operations for converting ticket intents and ticket field values into the ticket fields generation file. Operations may include (i) grouping (or clustering) incoming ticket field values, (ii) sub-grouping (or clustering) the ticket field values by intents, (iii) pruning poorly represented intents from the sub-groups and allocating them to other or new sub-groups, (iv) removing intents that are present in more than one sub-group from all but one sub-group, and (v) organizing each of the sub-groups, which contain all of the intents each uniquely associated with a ticket field value, into a file. This file may further contain instructions on how the file is to be used, such that the file can be input into an LLM as a prompt for configuring the LLM.

Ticket Field Prediction Model. An LLM can be configured to perform a certain task given an appropriate prompt, such that the prompt may include both relevant information for answering subsequent queries and instructions on how to answer and format such queries (e.g., provide a JSON structured output for a set of categories and write a summary of the results). The ticket field prediction model is a model, for example an LLM, that is prompt engineered with at least a ticket fields definition file to perform the task of providing ticket field values from incoming service ticket intents. A system implementing the ticket fields definition file may provide solutions to ticket routing where the service tickets used to generate the ticket fields definition file have either no or unreliable service ticket field values. Additionally, the system implementing the ticket fields definition file can be configured to provide both categorical and numerical outputs to incoming service ticket intents, such that aspects such as payroll impact (for example) may be identified with a numerical confidence score.

### First Exemplary Architecture

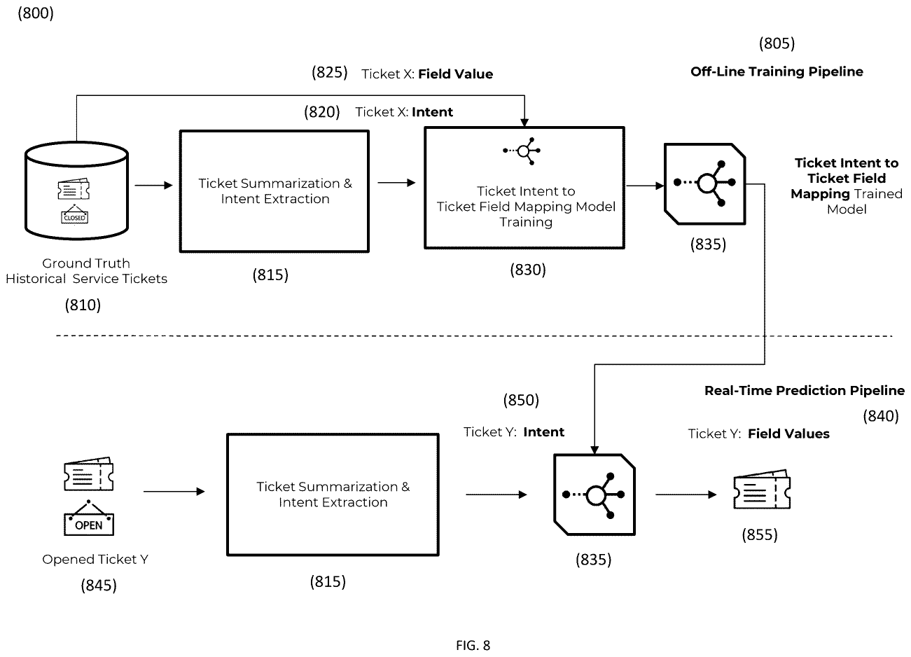

FIG. 8 shows a non-limiting exemplary logical architecture 800 for an off-line and real-time pipeline for predicting ticket field values from service tickets. In some embodiments, the architecture may comprise an off-line training pipeline 805 that may be used to train a ticket intent to ticket field values model 835. In some embodiments, the training of the ticket intent to ticket field values model may comprise a database 810 of historical service tickets with known field values. The historical service tickets may be associated with one or more historical service ticket field values 825. In some embodiments, a plurality of historical service tickets may be used as input into a ticket summarization and intent extraction model 815 to obtain one more historical service ticket intents 820 for each of the plurality of historical service tickets. A ticket intent to ticket field values model training 830 process may take as input the one or more historical service ticket intents and learn to output the one or more historical service ticket field values 825. In some embodiments, this process may provide the trained ticket intent to ticket field values model 835. In a real-time prediction pipeline 840, the trained ticket intent to ticket field values model 835 may be implemented so as to be used with an open service ticket 845. In some embodiments, the open service ticket 845 may pass through the ticket summarization and intent extraction model 815 to obtain one or more intents of the open service ticket 850. The one or more intents of the open service ticket 850 may be used as input into the trained ticket intent to ticket field values model 835 to obtain one or more open service ticket field values 855.

In some embodiments, the ticket intent to ticket field values model training 830 process may take as truth a mapping between the historical service tickets of the database 810 and the one or more historical service ticket field values 825. In some embodiments, the one or more historical service ticket intents 820 may be considered as the true input feature for the intended (true) output of the ticket intent to ticket field values model 835 trained via the ticket intent to ticket field values model training 830 process.

### Second Exemplary Architecture

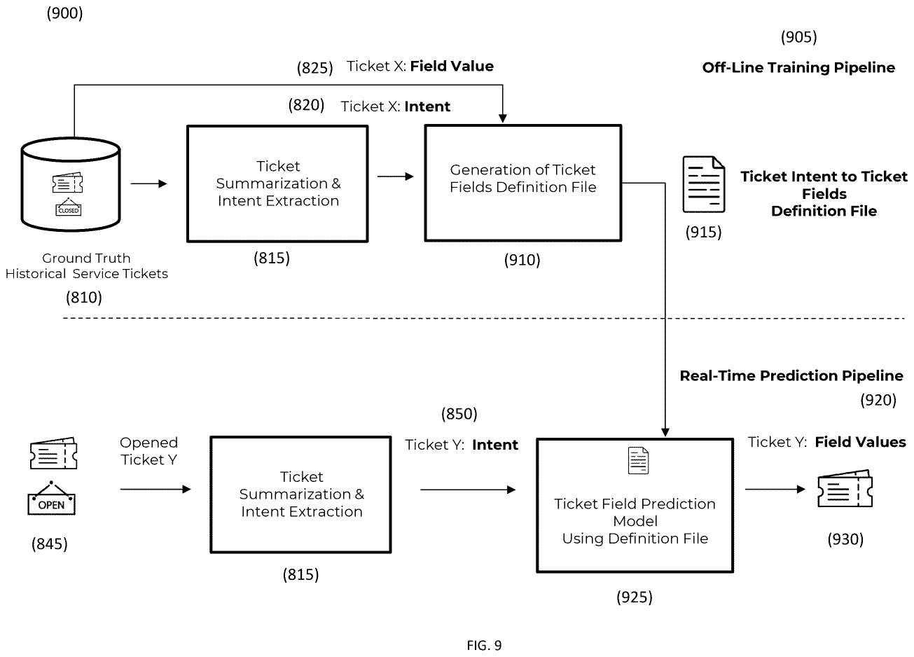

FIG. 9 shows a non-limiting exemplary logical architecture 900 for an off-line 905 and real-time 920 pipeline for predicting ticket field values from service tickets and a ticket fields value definition file. In some embodiments, the off-line pipeline may comprise an off-line training phase, which may be used to generate a ticket fields definition file 915 from a plurality of historical service tickets from the database 810 of historical service tickets with known field values. In some embodiments, the field values associated with the plurality of historical service tickets may not be reliable. In some embodiments, the plurality of historical service tickets from the database 810 may be used as input into a ticket summarization and intent extraction model 815 such that one or more historical service ticket intents 820 may be predicted for each of the plurality of historical service tickets. The one or more historical service ticket intents 825 and the one or more historical service ticket field values 825 may be processed by a ticket field values definition file generator 910 to generate the ticket fields definition file 915. In some embodiments, the ticket field values definition file 915 may be used as a prompt for configuring (e.g., by prompt engineering) a ticket field prediction model 925. In some embodiments, the ticket field prediction model 925 may be implemented in a real-time pipeline 920. In some embodiments, an open service ticket 845 may be used as input into the ticket summarization and intent extraction model 815 to extract one or more open service ticket intents 850. In some embodiments, the one or more open service ticket intents may be used as input into the ticket field prediction model 925 to obtain one or more open service ticket field values 930.

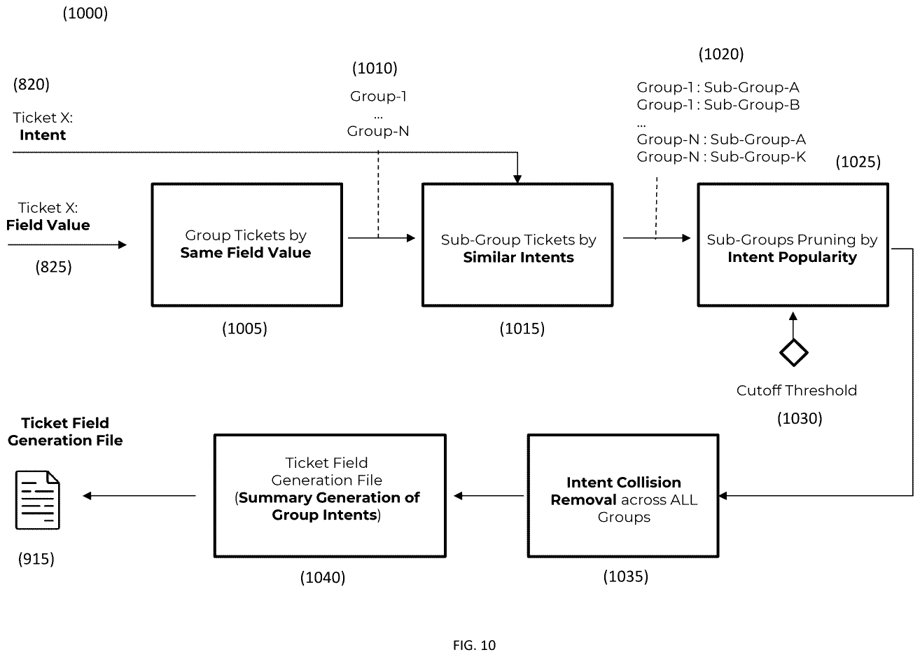

FIG. 10 shows a non-limiting example of a logical architecture 1000 of the ticket field values definition file generator 910. In some embodiments, the operations comprise a clustering or grouping operation 1005, where one or more historical service ticket field values 825 are clustered based on similarity among the one or more historical service ticket field values 825 to form one or more groups 1010. In some embodiments, the operations may further comprise a clustering or grouping operation 1015, where the groups are further divided by one or more historical service ticket intents 820, such that each of the one or more historical service ticket intents 820 are associated with at least one of the historical service ticket field values 825. In some embodiments, a pruning operation 1025 may be employed such that subgroups 1020 generated by the clustering operations may be reduced by a cutoff threshold 1030. In some embodiments, the cutoff threshold 1030 may comprise a percentage of intents to remove from each of the subgroups 1020, such that only intents that are well-represented in their sub-group are maintained. In some embodiments, the pruning operation may reduce the risk of mis-associations of intents with field values (e.g., an intent associated with a field value a single time may be an error or not representative of ticket routing practice). For example, the pruning operation 1025 may be combined with the cutoff threshold 1030 of, for example, 90%, wherein only the intents comprising the top 90% most common intents for the field value are retained. In some instances, one or more of the one or more historical service ticket intents 820 may be associated with more than one of the one or more historical service ticket field values 825. In some embodiments, the presence of an intent in more than one subgroup may comprise a collision event. In some embodiments, an intent collision removal operation 1035 may be implemented to remove overlapping intents (e.g., an intent of the one or more historical service ticket intents 820 present in more than one of the subgroups 1020). In some embodiments, the collision event may be resolved by one or more of human intervention or an automated resolution metric. In some embodiments, the automated resolution metric may comprise a recency of use metric (e.g., retain the intent in the group for which it was most recently associated) or a popularity of use metric (e.g., retain the intent in the group for which it is more often associated). In some embodiments, the intent collision removal operation 1035 may ensure that each of the one or more historical service ticket intents is associated with only one of the historical service ticket field values. In some embodiments, the subgroups 1020 may optionally be combined with at least a set of instructions for how to use or interpret the subgroups 1020 to ultimately form the ticket fields definition file 915. In some embodiments, the ticket fields definition file 915 may be in the form of a prompt for use in prompt engineering an LLM.

In some embodiments, the real-time pipeline 840 may use a manually entered ticket fields definition file 915. In some embodiments, the ticket fields definition file 915 may be combined with the one or more open service ticket intents 850 to form a prompt as input into the ticket field prediction model 925.

### Additional Aspects of First Architecture and Second Architecture

In some embodiments, the historical service tickets of the database 810 may be accessed from an enterprise database. In some embodiment, the enterprise database may comprise one or both of virtual or physical historical service tickets that may have been optionally closed by a service agent. In some embodiments, the historical service tickets of the database 810 may have user assigned or service agent (or other resolution resource) assigned ticket field values (e.g., categories, departments, error types, etc.).

In some embodiments, the historical service tickets may be processed by the ticket summarization and intent extraction model 815, where the model 815 is used to remove erroneous details from the historical service tickets (e.g., by summarization) and to extract intent from the historical service tickets (e.g., actionable items presented by the user, optionally enriched by details such as error codes, product names, etc.). In some embodiments, the historical service tickets may comprise natural language which may be difficult to parse and interpret without processing by an appropriate means such as the ticket summarization and intent extraction model 815. In some embodiments, the erroneous details removed may comprise a salutation (e.g., “hello”), an external link (e.g., a link to a site the user experienced the issue within), a proposed solution (e.g., an opinion on how the user would fix the issue), contact information (e.g., a user email), a personal identifier (e.g., a phone number or work ID), or narrative details (e.g., sentence components only used to tell a story, not describe an issue). In some embodiments, the erroneous details may comprise information poor data that may obfuscate intent. In some embodiments, the retained information may be used to generate a summary of the service ticket, which may be an information dense form of the user service ticket amenable to intent extraction. In some embodiments, the extracted intent may comprise a question (e.g., “how to fix mouse”), an issue (e.g., “mouse is broken”), or an information request (e.g., “instructions to fix mouse”). In some embodiments, the extracted intent may further comprise one or more of an error message, a status code, a warning message, a system warning, or a reference to a product. In some embodiments, the summarization and intent extraction model 815 may comprise one or more LLMs. In some embodiments, the one or more LLMs may be prompt engineered to perform each of the summarization or intent extraction operations. In some embodiments, one or more LLMs may provide the one or more historical service ticket intents 820 or the one or more open service ticket intents 850 and may be used in one or both of an off-line or real-time pipeline.

In some embodiments, the one or more historical service ticket field values 825 may be processed via a flattening operation. In some embodiments, the flattening operation may comprise converting the one or more historical service ticket field values 825 into a linear sequence of increasing historical service ticket field values granularity. In some embodiments, the linear sequence may comprise details that may be used to route service tickets to their appropriate resolution resource (e.g., service agent, domain expert). In some embodiments, the flattened form of the one or more historical service ticket field values 825 may be used as training labels during the ticket intent to ticket field values model training 830 process and may comprise the form of the historical service ticket field values or the one or more open service ticket field values 855. In some embodiments, the flattening operation. In some embodiments, the flattening operation may ensure a dependency chain for each component of the one or more historical service ticket field values or one or more open service ticket field values 855. In some embodiments, the dependency chain may comprise one or more categories or sub-categories, such that each subsequent component of the dependency chain depends from the earlier components of the dependency chain. In some embodiments, the dependency chain may ensure that categories and sub-categories are not incorrectly grouped and that the predictions of the ticket intent to ticket field values model 835 accurately reflect reasonable values for ticket field values. In some embodiments, the flattening operation may be used in the off-line pipeline 905 in the ticket field values definition file generator 910. In some embodiments, the flattening operation results in a format of <field 1; field 2 . . . ; field n>, where n is at least 1, 2, 3, 4, 5, 6, 7, 8, 9, 10, or more fields of an overall ticket field value. In some embodiments, the term category may refer to field 1, and sub-category may refer to field 2 to field n.

In some embodiments, the one or more open service ticket field values 855 of the real-time pipeline may be provided to resolution resource, where a resolution may comprise one or more of a service agent, a service team, a domain expert, a department, or a customer relationship management (CRM) software. In some embodiments, open service ticket field values 855 may provide grounded associations between the open service ticket field values 855 and one or more historical service ticket intents 825 so as to provide reliable, accurate, informed routing of service tickets to the resolution resource.

In some embodiments, one or more of the ticket intent to ticket field values model 835, the ticket intent and ticket summarization model 815, or the ticket fields prediction model 925 may comprise a component for encoding text (e.g., Strings) into one or more embeddings, where the one or more embeddings may be used to ultimately generate a latent space during a training operation. In some embodiments, the latent space may comprise learned embeddings of one or more of the historical service tickets of the database 810, the one or more historical service ticket intents 820, the one or more historical service ticket field values 825, or the ticket field values definition file 915. In some embodiments, an LLM comprising the latent space may be inferenced using natural language (which may represent one of the types of input used to generate the latent space) so as to ultimately provide the one or more open service ticket field values 930. In some embodiments, one or more of the models 835, 815, or 925 may leverage transfer learning to obtain a fine-tuned (e.g., domain specific) model state such that the model leverages a pre-existing general understanding of natural language augmented by data pertaining to a service ticket processing task or operation. In some embodiments, one or more of the models 835, 815, or 925 may implement a reinforcement learning paradigm to continually improve based on one or metrics of success of the real-time pipeline 920 or the real-time pipeline 840. In some embodiments, the one or metrics of success may comprise feedback from a resource resolution component (e.g., service agent, domain expert, CRM software) indicating the relevancy of a received service ticket (e.g., whether the ticket reached the right resource resolution component).

In some embodiments, one or more of the models 835, 815, or 925 may comprise prompt engineered LLMs, where a prompt may comprise a set of instructions or a data source from which to answer subsequent inquiries. In some embodiments, the subsequent inquiries may comprise entity extraction (e.g., model 815) or ticket field values prediction (e.g., model 835, model 925). In some embodiments, the set of instructions may comprise one or more distinct data processing operations. In some embodiments, the set of instructions may comprise an output format (e.g., JSON, natural language, flattened field values). In some embodiments, the prompt further comprises instructions on how to fill in the output format (e.g., a form), wherein the output format comprises one or more key-value pairs, wherein the keys of the one or more key-value pairs comprise a category, a category confidence, one or more sub-categories, one or more sub-category confidences, an issue type, an issue type confidence, a payroll impact, a payroll impact confidence, a system, or a system confidence.

### EXAMPLES

The following illustrative examples are representative of embodiments of the platforms, systems, media, and methods described herein and are not mean to be limiting in any way.

### Example 1—Prompt Engineering of Ticket Field Prediction Model

The following is an exemplary prompt input into an LLM to achieve ticket field values extraction from an exemplary ticket field values definition file, followed by an output of the prompt engineered model.

Input into an LLM

```
  Act as customer support agent assistant. Your job is to process a
user request in the form of an email (subject and body) and predict the
value for each ticket field in a ticketing system. Return a valid JSON
like:
  {
  “category”: str,
  “category_confidence”: float,
  “subcategory”: str,
  “subcategory_confidence”: float,
  “issue_type”: str,
  “issue_type_confidence”: float,
  “payroll_impact”: str,
  “payroll_impact_confidence”: float,
  “system”: str,
  “system_confidence”: float
  }
  The “category” field contains the predicted category.
  The “subcategory” field contains the predicted subcategory.
  The “issue_type” field contains the predicted issue type.
  The “payroll_impact” field contains the predicted payroll impact
type. “1” is True. “2” is False.
  The “system” field contains the predicted system.
  The “confidence” field should contain a normalized score between 0
and 1.
  The categories and subcategories are given as follows:
  {
  ‘add_request_associate_file (related to request to add/upload
associate documents like employment certificate/letter like title/job
change letter, transfer letter, contract, signed copy of
document/statement/contract, educational document like
diploma/transcript) ’: [ ],
  ‘alcon_free_contact_lens_program (related to Alcon Free Contact Lens
Program) ’: [ ],
  ‘background_check_exception (related to background check / court
order/records exceptions) ’ : [ ],
  ‘create_or_change_ supervisory_org (related to create/change
supervised organization (also shortened as ’sup org’) ) ’ : [ ],
  ‘employee_data management_general_inquiry (related to employee data
management in Workday and troubleshoot access/login issues to Workday
(also known as WD) which covers the topics described in the
subcategories) ’: [‘Access Inquiry (troubleshoot access/login issues to
Workday) ’, ‘Address Change Inquiry (related to change employee
home /work/company address/location) ’, ‘Banking/Direct Deposit Inquiry
(related to direct deposit/bank account/payment method
election) ’, ‘Contingent Worker Request (related to request to change
Start/End Employment Date for contingent workers) ’, ‘Documentation
Request (related to request for associate documents like employment
certificate/letter (like title/job change letter, transfer
letter) /contract, EP152 form, signed copy of document/statement/contract,
educational document like diploma/transcript)’, ‘E-File Request (related
to request to E-File/ Pfile (P File) documents’, ‘Employment Verification
Request (related to request/sign/return employment verification
process ) ’, ‘Government ID Inquiry (related to UAN/PAN/ BPJS number,
visa/visa status) ’, ‘Legal Name Inquiry (related to change/correct
employee legal name/last name/name) ’, ‘Pay Rate (related to process and
correction of base pay/pay rate/hourly rate) ’, ‘Probation Related Inquiry
(related to probation inquiries) ’, ‘Profile Inquiry (related to changes in
employee profile like change employee job title/job, employee ID (user
ID, global ID), employee Start/End Employment Date, employee team
structure’, ‘Termination Letter Request (related to request to terminate
employee / termination letter (leaver letter) ’, ‘General Inquiry (related
to employee data management inquiries which are not specifically covered
by the subcategories described above for this category) ’, ],
  ‘employee_org_management_general_inquiry (related to employee
organization management which covers the topics described in the
subcategories) ’: [‘Cost Center Inquiry (related to employee Cost Center
(shortened with CC) ’, ‘Job Profile Inquiry (related to change in employee
job profile/job title’,‘Operational Manager Inquiry (related to chance in
employee reporting manager’, ‘Position Related Inquiry (related to change
in employee job position/job level’, ‘Supervisory Org Inquiry (related to
employee/contingent worker move or remove employee/contingent worker
from headcount) ’, ‘General Inquiry (related to employee org management
inquiries which are not specifically covered by the subcategories
described above for this category’ ],
  ‘employee_recognition_inquiry (inquiries related to employee
recognition/recognition program, or access to Recogneyes
system) ’ : [‘General Inquiry’],
  ‘general_compensation_inquiry (inquiries related to compensation
like change and correct salary/pay/compensation/grade profile, or access
to ADP pay portal) ’: [‘General Compensation Inquiry’ ],
  ‘global_mobility_general_inquiry (inquiries related to employee
relocation, employee travel) ’: [‘Relocation Inquiry’ ],
  ‘hr_interface_monitoring (inquiries related to hr interface
monitoring and troubleshooting like interface is not working, interface
run error, interface not working as expected) ’ : [‘General Inquiry’ ],
  ‘hr_system_security_general_inquiry (related to provision access/new
login information for Workday (also known as WD) and management of
user roles and permissions in Workday which covers the topics described
in the subcategories) ’: [‘New Access Request (related to request new
access/provision access and new login credentials (username and password)
for Workday and all Workday modules like Learning Partner, US
Commercial, etc.) ’, ‘New Role/Security Profile Request (related to
assignment and management of user roles and permissions in Workday’],
  ‘hris_enhancement (inquiries related to hris enhancement) ’ : [ ],
  ‘job_evaluation (inquiries related to job evaluation/job description
evaluation new role) ’: [‘Job Evaluation - New Role’],
  ‘leave_of_absence_inquiry (related to leave of absence (also known
as LOA or LA or Absence) of type medical leave, childcare leave, injury
leave, time off, parental (paternity) leave, annual leave, sick leave,
etc., and covers the topics described in the subcategories) ’ : [‘Accrual
Balance Inquiry (related to leave accrual balance (leave balance), leave
balance, leave hours carry over, change/correct leave balance)
’, ‘Documentation Inquiry (related to request
documentation/letters/certificates related to any type of leave) ’, ‘I need
to Request a Leave (related to take a leave which is neither time off nor
parental leave, nor sick leave) ’, ‘I need to Request Time Off (related to
take/approve time off) ’, ‘Parental Leave (related to
take/cancel/extend/approve parental leave) ’, ‘Sick Leave (related to
take/cancel/extend/approve sick leave / time of for sickness) ’, ‘Policy
Inquiry (related to any leave type policy) , ‘Process Related’ , \Time Off
Reporting Inquiry (related to correct errors in reporting/registering any
type of leave, including time off) ’],
  ‘merit_bonus_inquiry (inquiries related to merit and short term
incentives (also known as STI) which covers the topics described in the
subcategories) ’: [‘Merit (related to assign /remove employees/associates
from merit/merit plan) ’, ‘Short Term Incentive (related to check
employee/associate eligibility for STI, missing (STI) segment,
update/change/adjust employee STI) ’],
  ‘my_pay (inquiries related to paycheck/payslip/pay stub/direct
deposit payment which covers topics described in the subcategories) ’:
[‘Error in my Paycheck (related to pay errors in paycheck/payslip/pay
stub/direct deposit payment/paypal account’, ‘Paycheck Error-Error in my
Allowance (related to errors in pay allowance to employee for vacation,
pto, fitness/wellness, entertainment, disability, transportation,
etc. ) ’, ‘Paycheck not Received (related to missing pay in
paycheck/payslip/pay stub/direct deposit payment/paypal account) ’,
‘Request Copy of Pay Stub/Payslip (related to request a copy of
pay stub/payslip/paycheck) ’, ‘Request Form: Pay Verification (related to
employee pay verification) ’, ‘General Associate Paycheck Inquiry’,
‘Request Electronic Access to Pay Stub/Payslip (related to issues with
access electronic pay stub/payslip in ADP’],
  ‘onboarding_inquiry (inquiries related to new joiner/new hire
onboarding tasks like onboarding process details, request/missing new
joiner/new hire laptop, assistance with onboarding task, issue with first
login to workday) ’ : [‘General Inquiry’],
  ‘payment_deduction_request (inquiries related to payment deductions
which covers topics described in the subcategories) ’ : [‘Correction
(related to missing allowances/deductions in payroll or other incorrect
payroll calculation, etc.)’, ‘Eligibility/Policy Related (related to
eligibility/policy for payment/allowances/deductions like overtime,
traffic penalty deductions, etc.) ’ , ‘New’, ‘ Paycheck Request (related to
request for payment/reimbursement/payment reconciliation) ] ,
  ‘payroll_accounting (inquiries related to payroll
accounting) ’ : [‘account posting controls’ ],
  ‘payroll_reporting_and_data (inquiries related to payroll report,
like sales incentives report, payroll forecast, or payroll audit) ’ :
[‘Audit Inquiry (related to audits) ’, ‘New Report Inquiry (related to
payroll reports’],
  ‘payroll_tax (inquiries related to payroll tax/taxation and tax
forms which covers topics described in the subcategories) ’ : [‘Associate
Tax Inquiry/Request (related to associate tax inquiries, tax withholding
rate and elections, tax deductions, income tax certificates) ’, ‘Tax Filing
Inquiry (related to tax filing inquiry) ’, ‘Tax Form Inquiry (related to
tax forms like W-2, W-4, PIT-11, Form-16) ’] ,
  ‘payroll_termination_actions (inquiries related to payroll
termination actions which are covers the topics described in the
subcategories) ’: [‘Final Paycheck Request (related to final
paychecks/payouts) ’, ‘Severance (related to severance payouts/liquidation
payouts) ’, ‘Vacation Annual Leave Payout (related to annual leave
payouts and balance’ ],
  ‘performance_inquiry (inquiries related to employee performance
review, and manage performance goals like
edit/change/remove/create/archive goals) ’ : [‘Goal Setting Inquiry’],
  ‘rehire_eligibility (inquiries related to re-hire eligibility) ’: [ ],
  ‘request_knowledge_base article’ : [ ],
  ‘standard_benefits_inquiry (inquiries related to employee standard
benefits (benefits, vision, dental, medical, life insurance, multisport,
luxmed, etc.) which covers topics described in the subcategories) ’:
  [‘Access Issue (related to access and login credentials issues with
benefits portal/benefit account, Gofluent, Medi Assist/Medi Buddy’) ,
‘Communications Inquiry (related to benefits reports), ‘Enrollment
Inquiry (related to enrollment, registration and activation of
benefit/benefit plan/benefit insurance) ’, ‘Form Request (related to
request benefits forms, letters) ’, ‘Policy Inquiry (related to benefits
and insurance plans) ’, ‘Something wrong with my payment/deduction
(related to issues with benefits payment, contributions/contribution limit,
deductions) ’, ‘General Inquiry (any other benefits inquiry not covered by
the other subcategories) ’],
  ‘system_support_general_inquiry (inquiries related to assistance and
troubleshooting system support and correct system support data issues
which cover the topics described in the subcategories) ’: [‘Data Error
Inquiry (related to incorrect data/records in system support’, ‘Data
Upload Request (related to import/upload data/records in system support,
like OTP mass /bulk upload) ’, , ‘General System Maintenance Request
(related to request for maintenance of system Support) ’, ‘System
Functionality - New Request (related to functionality of system
support’, ‘ System is not Working as Expected (related to issue and
troubleshooting of system support) ’, ‘Workday Report Request’, ‘General
Inquiry’],
  ‘tas_general_inquiry (inquiries related to talent acquisition which
covers the topics described in the subcategories) ’ : [ ‘General Hiring
Process Inquiry (related to hiring process like open/close/post job
openings/positions, accept/decline job offers, preparation of employment
agreements/job requisitions, upload job interviews and
feedback) ’, ‘Recruiting Events (like attendance/registration/report on
recruiting events) ’],
  ‘time (inquiries related to access the time management system
(kronos) , manage timecards, request corrections in timecard / punches /
time off / absence balance) ’ : [‘Accessing Time System (related to access
and login credentials to time management system) ’, ‘Accrual Balance
Inquiry_Resets_Corrections (related to reset/revert back time accrual
balance) ’, ‘Calculate Flexi and_or OT Report (related to report
information about Flexible Time and Overtime (also known as OT)
calculation) ’, ‘Historical Data Entry Request (related to historical data
related to Punches/Time Off/Absences) ’, ‘Holiday Inquiry (related to
holidays) ’, ‘Reporting Inquiry (related to time management reporting) ’,
‘Schedule Inquiry (Related to schedule time / shifts)’, ‘Timecard
Calculation Inquiry (related to timecard calculation) ’, ‘Timecard
Correction Request (related to incorrect calculation of time off’]
  }
  The issue types are: [‘Request: Employee Data Transaction’,
‘Correction Needed: Payroll/Time Input Er’, ‘Request: Technical/System
Config’, ‘Correction Needed: User Input Error’, ‘Correction Needed:
Technical/System Error’, ‘Correction Needed: Unknown Root Cause’,
‘Correction Needed: HRIS Input Error’, ‘Correction Needed: HRSS Input
Error’]
  The possible payroll impacts are “1” and “2”.
  The possible system types are: [‘Workday (related to Workday/WD) ’,
‘payroll_adp (Related to ADP)’, ‘time_kronos (related to kronos) ’,
‘Alfresco (related to employee records / Alfresco) ’,
‘payroll_other_system (related to payroll system which is not
ADP/NGA/SDWorx/Promenics/PKK)’, ‘Time - ATOSS (related to time /
ATOSS) ’, ‘Payroll - NGA (related to NGA) ’, ‘vendor_system’,
‘Time - PrimeTime (related to PrimeTime) ’, ‘Payroll - SD Worx
(related to SSD Worx/DWorx) ’,
‘time_other_system (related to time management system which is not
Kronos /ATOSS/ PrimeTime/EuHRka) ’, ‘servicenow (related to SNOW) ’,
‘Payroll - Promenics (related to Promenics) ’, ‘Payroll - PKK
(related to PKK) ’, ‘JDXpert related to JDXpert/job description
management) ’, ‘Time - EuHRka (related to EuHRka) ’,
‘recogneyes (related to employee recognition) ’,
‘vendor_integration’, ‘walk_me (related to WalkMe) ]
```

### Output of Prompt Engineered LLM

An example of output when using the above prompt for ticket “need to change my home address” is shown below.

{
“category”: “employee_data_management_general_inquiry”,
“category_confidence”: 0.9
“subcategory”: “Address Change Inquiry”,
“subcategory_confidence”: 0.8
“issue_type”: “Request Employee Data Transaction”,
“issue_type_confidence”: 0.9
“payroll_impact”: “2”,
“payroll_impact_confidence”: 0.9,
“system”: “Workday (related to Workday/WD)”,
“system_confidence”: 0.9
}

### Example 2—Flattening Ticket Field Values

In one instance, a ticket field value can have two primary categories, “hardware” or “software.” Hardware can have specific sub-categories “computer,” “server,” or “peripheral.” Software can have specific sub-categories “video-conferences,” “file management,” or “virtual desktop.” These dependencies are capture by flattening an incoming ticket with one category and sub-category such that it is clear that the sub-category is associated with the appropriate category.

An exemplary input into the flattening operation comprises “hardware” and “computer.”

An exemplary output of the flattening operation is <hardware; computer>.

The category computer has further sub-categories “desktop” and “laptop.”

An exemplary input into the flattening operation comprises “hardware,” “computer,” and “laptop.”

An exemplary output of the flattening operation is <hardware; computer; laptop>.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A computer-implemented method of ticket field value prediction from historical service tickets comprising:
a) providing an off-line training pipeline configured to perform off-line operations including:
i. receiving a plurality of historical service tickets each comprising one or more historical service ticket field values,
ii. applying a ticket summarization and intent extraction model configured to perform operations including:
1. summarizing each of the plurality of historical service tickets to generate a plurality of historical service ticket summaries, wherein the summarizing operation removes erroneous details from the plurality of historical service tickets, and
2. extracting one or more historical service ticket intents from each of the plurality of historical service ticket summaries,
iii. training a ticket intent to ticket field values model using the one or more historical service ticket intents and the one or more historical service ticket field values to predict the historical service ticket field values from the historical service ticket intents; and
b) providing a real-time prediction pipeline configured to perform real-time operations including:
i. receiving an open service ticket,
ii. applying the ticket summarization and intent extraction model configured to perform operations including:
1. summarizing the open service ticket to generate an open service ticket summary, wherein the summarizing operation removes erroneous details from the open service ticket, and
2. extracting one or more open service ticket intents from the open service ticket summary,
iii. applying the ticket intent to ticket field values model to predict one or more open service ticket field values from the one or more open service ticket intents, and
iv. providing the one or more open service ticket field values.

2. The method of claim 1, wherein the ticket summarization and intent extraction model comprises a large language model (LLM).

3. The method of claim 1, wherein the erroneous details comprise one or more of a salutation, an external link, a proposed solution, contact information, a personal identifier, or narrative details.

4. The method of claim 1, wherein the summarizing operation of the off-line operations or the real-time operations generates a summary, wherein the summary comprises one or more of an error message, a status code, a warning message, a system warning, a reference to a product, or an intent.

5. The method of claim 1, wherein the one or more historical service ticket intents or the one or more open service ticket intents indicate an information request, an issue, or a question.

6. The method of claim 1, wherein the one or more open service ticket field values are used to route the open service ticket to one or more of a service agent, a department, a domain expert, or a customer relationship management (CRM) software.

7. The method of claim 1, wherein the historical service ticket field values or the open service ticket field values comprise at least one category, wherein a second or later category further defines the at least one category.

8. The method of claim 1, wherein the off-line operations further include flattening the one or more historical service ticket field values to comprise a sequence of dependent field values.

9. The method of claim 8, wherein the flattening operation is used to generate a label for training the ticket intent to ticket field values model.

10. The method of claim 1, wherein the ticket intent to ticket field values model comprises an LLM.

11. The method of claim 1, wherein the ticket intent to ticket field values model is trained on a library of historical service tickets, wherein the library comprises at least 100, 1000, 10,000, or 100,000 historical service tickets.

12. A computer-implemented method for ticket field values predictions from historical service tickets comprising:
a) providing an off-line prediction pipeline configured to perform off-line operations including:
i. receiving a plurality of historical service tickets each comprising one or more historical service ticket field values,
ii. applying a ticket summarization and intent extraction model configured to perform operations including:
1. summarizing each of the plurality of historical service tickets to generate a plurality of historical service ticket summaries, wherein the summarizing operation removes erroneous details from the plurality of historical service tickets, and
2. extracting one or more historical service ticket intents from each of the plurality of historical service ticket summaries,
iii. generating a ticket fields definition file comprising each of the historical service ticket field values, wherein each of the plurality of historical service ticket intents is mapped to one of the one or more historical service ticket field values; and
b) providing a real-time prediction pipeline configured to perform real-time operations including:
i. receiving an open service ticket,
ii. applying the ticket and summarization and intent extraction model configured to perform operations including:
1. summarizing the open service ticket to generate an open service ticket summary, wherein the summarizing operation removes erroneous details from the open service ticket, and
2. extracting one or more open service ticket intents from the open service ticket summary,
iii. providing a prompt comprising the ticket fields definition file or the one or more open service ticket intents to a ticket field prediction model to predict one or more open service ticket field values, and
iv. providing the one or more open service ticket field values.

13. The method of claim 12, wherein the generating the ticket fields definition file comprises operations including:
a) clustering the historical service tickets by the one or more historical service ticket field values to form one or more groups,
b) clustering the one or more groups by the one or more historical service ticket intents to form one or more sub-groups,
c) removing a weakly represented portion of the one or more historical service ticket intents from each of the one or more sub-groups based on a cutoff threshold of proportional representation,
d) removing a colliding historical service ticket intent from all except one of the one or more sub-groups, wherein the colliding historical service ticket intent comprises a historical service ticket intent associated with at least two of the one or more sub-groups, and
e) generating the ticket fields definition file comprising the one or more sub-groups, wherein the one or more sub-groups of the ticket fields definition file comprise unique associations between the one or more historical service ticket intents and the one or more historical service ticket field values.

14. The method of claim 13, wherein the colliding event is removed based on one or more metrics comprising a recency of association of the historical service ticket intent with the one or more sub-groups or a popularity of association of the historical service ticket intent with the one or more sub-groups.

15. The method of claim 13, wherein the cutoff threshold is set to retain 10%, 20%, 30%, 40%, 50%, 60%, 70%, 80%, 90%, or 100% historical service ticket intents.

16. The method of claim 13, wherein the generating the ticket fields definition file operations further include forming a sub-group using the portion of weakly represented historical service ticket intents.

17. The method of claim 13, wherein the generating the ticket fields definition file operations further include summarizing each sub-group.

18. The method of claim 12, wherein the generating the ticket fields definition file is performed by a large language model (LLM).

19. The method of claim 12, wherein the providing the prompt operation of the real-time operations comprises operations including:
a) prompt engineering the ticket field prediction model with at least the ticket fields definition file, and
b) predicting the one or more open service ticket field values using the prompt engineered ticket field prediction model.

20. The method of claim 12, wherein the ticket field prediction model is an LLM.

21. The method of claim 12, wherein the prompt further comprises instructions to complete a form, wherein the form comprises one or more key-value pairs, wherein the keys of the one or more key-value pairs comprise a category, a category confidence, one or more sub-categories, one or more sub-category confidences, an issue type, an issue type confidence, a payroll impact, a payroll impact confidence, a system, or a system confidence.

22. The method of claim 12, wherein the ticket summarization and intent extraction model comprises an LLM.

23. The method of claim 12, wherein the erroneous details comprise one or more of a salutation, an external link, a proposed solution, contact information, a personal identifier, or narrative details.

24. The method of claim 12, wherein the summarizing operation of the off-line operations or the real-time operations generates a summary, wherein the summary comprises one or more of an error message, a status code, a warning message, a system warning, a reference to a product, or an intent.

25. The method of claim 12, wherein the one or more historical service ticket intents or the one or more open service ticket intents indicates an information request, an issue, or a question.

26. The method of claim 12, wherein the one or more open service ticket field values are used to route the open service ticket to one or more of a service agent, a department, a domain expert, or a customer relationship management (CRM) software.

27. The method of claim 12, wherein the historical service ticket field values or the open service ticket field values comprise at least one category, wherein a second or later category further defines the at least one category.

28. The method of claim 12, wherein the off-line operations further include flattening the one or more historical service ticket field values to comprise a sequence of dependent field values.

29. The method of claim 12, wherein the ticket fields definition file is generated by a person.

30. A computer-implemented system comprising at least one processor and instructions causing the at least one processor to perform operations comprising:
a) providing an off-line training pipeline configured to perform off-line operations including:
i. receiving a plurality of historical service tickets each comprising one or more historical service ticket field values,
ii. applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries,
iii. training a ticket intent to ticket field values model using the one or more historical service ticket intents and the one or more historical service ticket field values to predict the historical service ticket field values from the historical service ticket intents; and
b) providing a real-time prediction pipeline configured to perform real-time operations including:
i. receiving an open service ticket,
ii. applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary,
iii. applying the ticket intent to ticket field values model to predict one or more open service ticket field values from the one or more open service ticket intents, and
iv. providing the one or more open service ticket field values.

31. A computer-implemented system comprising at least one processor and instructions causing the at least one processor to perform operations comprising:
a) providing an off-line prediction pipeline configured to perform off-line operations including:
i. receiving a plurality of historical service tickets each comprising one or more historical service ticket field values,
ii. applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries,
iii. generating a ticket fields definition file comprising each of the historical service ticket field values, wherein each of the plurality of historical service ticket intents is mapped to one of the one or more historical service ticket field values; and
b) providing a real-time prediction pipeline configured to perform real-time operations including:
i. receiving an open service ticket,
ii. applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary,
iii. providing a prompt comprising the ticket fields definition file or the one or more open service ticket intents to a ticket field prediction model to predict one or more open service ticket field values, and
iv. providing the one or more open service ticket field values.

32. One or more non-transitory computer-readable storage media encoded with instructions executable by one or more processors to provide an application comprising:
a) a software module providing an off-line training pipeline configured to perform off-line operations including:
i. receiving a plurality of historical service tickets each comprising one or more historical service ticket field values,
ii. applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries,
iii. training a ticket intent to ticket field values model using the one or more historical service ticket intents and the one or more historical service ticket field values to predict the historical service ticket field values from the historical service ticket intents; and
b) a software module providing a real-time prediction pipeline configured to perform real-time operations including:
i. receiving an open service ticket,
ii. applying the ticket summarization and intent extraction model configured to perform operations including: summarizing the open service ticket to generate an open service ticket summary, wherein the summarizing operation removes erroneous details from the open service ticket, and extracting one or more open service ticket intents from the open service ticket summary,
iii. applying the ticket intent to ticket field values model to predict one or more open service ticket field values from the one or more open service ticket intents, and
iv. providing the one or more open service ticket field values.

33. One or more non-transitory computer-readable storage media encoded with instructions executable by one or more processors to provide an application comprising:
a) a software module providing an off-line prediction pipeline configured to perform off-line operations including:
i. receiving a plurality of historical service tickets each comprising one or more historical service ticket field values,
ii. applying a ticket summarization and intent extraction model configured to perform operations including: summarizing each of the plurality of historical service tickets to generate a plurality of historical service ticket summaries, wherein the summarizing operation removes erroneous details from the plurality of historical service tickets, and extracting one or more historical service ticket intents from each of the plurality of historical service ticket summaries,
iii. generating a ticket fields definition file comprising each of the historical service ticket field values, wherein each of the plurality of historical service ticket intents is mapped to one of the one or more historical service ticket field values; and
b) a software module providing a real-time prediction pipeline configured to perform real-time operations including:
i. receiving an open service ticket,
ii. applying the ticket and summarization and intent extraction model configured to perform operations including: summarizing the open service ticket to generate an open service ticket summary, wherein the summarizing operation removes erroneous details from the open service ticket, and extracting one or more open service ticket intents from the open service ticket summary,
iii. providing a prompt comprising the ticket fields definition file or the one or more open service ticket intents to a ticket field prediction model to predict one or more open service ticket field values, and
iv. providing the one or more open service ticket field values.
